(19) United States
(12) Patent Application Publication
(10) Pub. No.: US 2018/0150036 A1
(43) Pub. Date: May 31, 2018

(54) SYSTEMS AND METHODS FOR CONCEPT DRIFT LEARNING WITH ALTERNATING LEARNERS

(71) Applicant: General Electric Company, Schenectady, NY (US)

(72) Inventors: Yunwen Xu, Freemont, CA (US); Paul Ardis, Niskayuna, NY (US); Rui Xu, Rexford, NY (US); Weizhong Yan, Clifton Park, NY (US)

(21) Appl. No.: 15/820,963

(22) Filed: Nov. 22, 2017

Related U.S. Application Data
(60) Provisional application No. 62/426,839, filed on Nov. 28, 2016.

(51) Int. Cl. G05B 13/04

(52) U.S. Cl. CPC G05B 13/041; G06Q 10/20

(57) ABSTRACT

According to some embodiments, a system and method are provided to model a sparse data asset. The system comprises a processor and a non-transitory computer-readable medium comprising instructions that when executed by the processor perform a method to model a sparse data asset. Relevant data and operational data associated with the newly operational are received. A transfer model based on the relevant data and the received operational data. An input into the transfer model is received and a predication based on data associated with the received operational data and the relevant data is output.

### BACKGROUND

Industrial assets are engineered to perform particular tasks as part of industrial processes. For example, industrial assets can include, among other things and without limitation, generators, gas turbines, power plants, manufacturing equipment on a production line, aircraft engines, wind turbines that generate electricity on a wind farm, power plants, locomotives, healthcare or imaging devices (e.g., X-ray or MRI systems) for use in patient care facilities, or drilling equipment for use in mining operations.

Early detection and diagnosis of problems associated with an industrial asset may help minimize downtime of the industrial asset as well as prevent secondary damage. For example, when an industrial asset fails, the industrial asset may cause damage to various asset components or to the industrial asset's surroundings which may create longer downtimes. It would therefore be desirable to provide a system to determine problems or potential problems associated with an industrial asset as early as possible to provide time for a repair crew to address the determined or potential problems associated with the industrial asset.

### SUMMARY

Some embodiments described herein relate to a system and a method to determine an industrial asset event. The system comprises a processor and a non-transitory computer-readable medium comprising instructions that when executed by the processor perform a method. A short- memory model associated with the industrial asset and a long-memory model associated with the industrial asset may be received and an industrial asset event may be determined based on the short-memory model and the long-memory model.

A technical advantage of some embodiments disclosed herein are improved systems and methods for the early alerting of potential problems associated with assets prior to secondary damage being done to the industrial asset and/or the industrial asset's surroundings.

### BRIEF DESCRIPTION OF THE DRAWINGS

FIG. 1 illustrates a system in accordance with some embodiments.

FIG. 2 illustrates a method in accordance with some embodiments.

FIG. 3A illustrates a process in accordance with some embodiments.

FIG. 3B illustrates a sample window size according to some embodiments.

FIG. 4 illustrates a system according to some embodiments.

FIG. 5 illustrates a portion of a database according to some embodiments.

### DETAILED DESCRIPTION

In the following detailed description, numerous specific details are set forth in order to provide a thorough understanding of the embodiments. However, it will be understood by those of ordinary skill in the art that the embodiments may be practiced without these specific details. In other instances, well-known methods, procedures, components and circuits have not been described in detail so as not to obscure the embodiments.

The present embodiments relate to a system and method associated with learning from nonstationary data streams that exhibit concept drift. Concept drift may relate to statistical properties of a target variable that change over time in unforeseen ways. Concept drift often creates problems with modeling because the predictions created by the models may become less accurate as time passes due to properties of target variables changing. More specifically, the present embodiments may relate to a simple dual-learner ensemble strategy that uses an alternating learner framework for determining when events associated with an industrial asset may occur (e.g., an industrial asset event). Asset events, may comprise, but are not limited to, maintenance events associated with the industrial asset, operational change events, fuel change events, and asset part change events.

The present strategy may utilize both a long-memory model that may learn stable concepts based on a long relevant time window of data associated with an industrial asset as well as a short-memory model that may learn transient concepts associated with the industrial asset from a small recent window. A difference in prediction performance of these two models may be monitored and may induce a policy to select, update and reset the two models as well as determine when an industrial asset event associated with the industrial asset may occur.

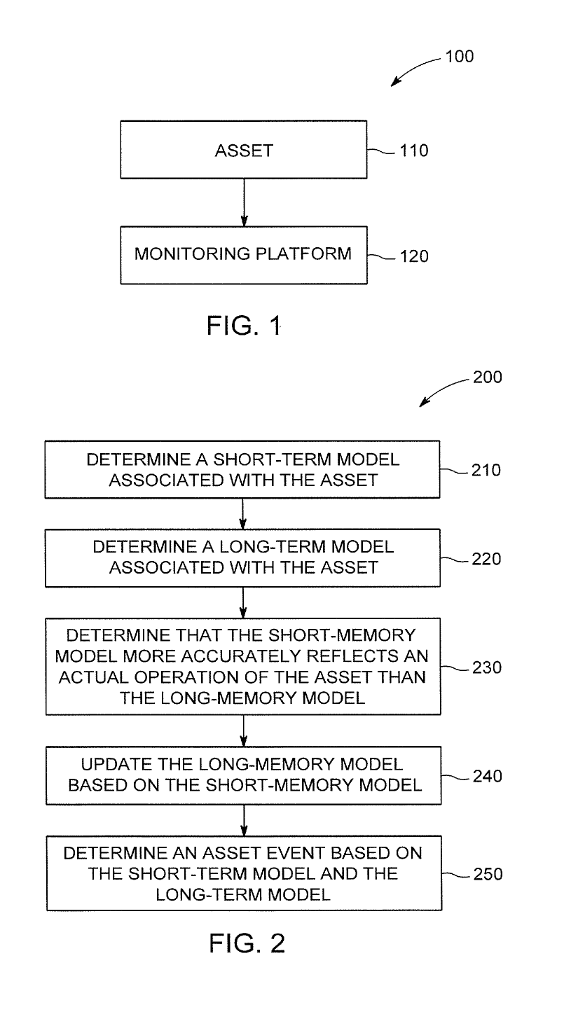

Now referring to FIG. 1, an embodiment of a system 100 is illustrated. As illustrated in FIG. 1, the system 100 may comprise an industrial asset 110 and a monitoring platform 120. The industrial asset 110 may comprise, among other things, and without limitation, generators, gas turbines, power plants, manufacturing equipment on a production line, aircraft engines, wind turbines that generate electricity on a wind farm, power plants, locomotives, healthcare or imaging devices (e.g., X-ray or MRI systems) for use in patient care facilities, or drilling equipment for use in mining operations.

The monitoring platform 120 may receive data from a plurality of sensors associated with the industrial asset (e.g., streaming time-series data) or may receive periodic data that are input into the monitoring platform. The monitoring platform 120 may compare the received data to one or more existing models to determine an industrial asset event. The models used by the monitoring platform 120 may be associated with an alternating learners (AL) framework that is used for analyzing data received from the industrial asset 110. For example, a set of labeled data (henceforth referred to as the initial dataset) may be available at a beginning of a learning process. The initial dataset may be generated from a design of experiments (DoE), testbed runs or historical operation records. As an industrial asset is operated, new data (e.g., streaming data comprising new measurements with labels) may become available either in a stream, one batch of data at a time, or in small batches where it may not be necessary to have equal batch sizes. In some embodiments, the initial dataset may not be sufficient for modeling an industrial asset due to a limited duration of operation of the industrial asset. Due to limited operation, the initial data set may not contain data associated with specific operation modes (e.g., different conditions in which the industrial asset may operate). The AL framework may comprise two learning models, a long-memory learner (L) and a short-memory learner (S) and an alternating policy may be employed to choose the final prediction output either from L or from S.

The AL framework may comprise two phases: an initial learning phase and a continuous learning phase. In the initial learning phase, predictive models may be built from the initial dataset. In some embodiments, L may be initially trained by both the initial dataset and by S where at most W samples from a latter portion of S are used where W comprises a user defined window size associated with a short memory window (SW). In some embodiments of the short-memory model, only samples in SW will be kept in memory. L may be used to capture a feature-response relationship over a window [T0; T] with relevant data which may be defined as LW (e.g., a long memory window). S may model a “current” window of size W which, as indicated above, is referred to as SW. LW and SW may alternatively define a beginning of the learning window for stationary and changing environments respectively. In the continuous learning phase, learning may be based on the two models (L and S) by updating, comparing, and selecting one of the two models using new available data. The process of determining an industrial asset event will now be described in more detail with respect to FIG. 2.

Now referring to FIG. 2, a method 200 that might be performed by the monitoring platform 120 of the system 100 described with respect to FIG. 1 is illustrated according to some embodiments. The flow chart described herein does not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

Method 200 relates to determining asset events when concept drift is present. In many industrial use cases associated with assets, data received from a manufacture and operation processes may demonstrate an inherent nonstationary nature. For example, data may vary due to a sensor's measurement drifting due to the sensor being faulty or by the sensor aging, data may vary due to changes in operation conditions or control command, and/or data may vary due to one or more components of the industrial asset degrading as a result of wearing. Even without seeing any drift in available data, there is no guarantee that data that will become available in the future will follow a similar distribution as past data. Concept drift may relate to an unseen, or uncertain change in data, or in a process that generates the data. Concept drifts may comprise a virtual drift or a real drift. A virtual drift may relate to a change in a data distribution P(Xt), so that a fitted model that achieves optimal averaged prediction performance for one period of time (the training phase) is no longer optimal for the new test data. For example, changes purely caused by seasonal effect and operational condition (e.g., temperature, humidity) are examples of virtual drift. On the other hand, real drift may relate to machine degradation. Once a drift is detected, models may be retrained or incrementally updated with valid training data from recent experience or through resampling.

Now referring to 210, a short-memory model (S) associated with an industrial asset may be determined. The short-memory model associated with the industrial asset may comprise any type of model such as, but not limited to, a physics based model or a data-driven model. A physics model may be defined as a model that comprises all the relevant physical parameters needed to simulate behavior of a specific asset. A physics model of an industrial asset typically contains hundreds of parameters (e.g., geometric quantities and experimental data); these must be calibrated to the specific asset across its operating range. Data-driven models may be based on data collected from the industrial asset and may require an initial data collection period and may require data collected over different operation modes (e.g., unseen weather conditions, unseen operational conditions, etc.) before providing accurate predictions.

The short-memory model may be based on performance of the industrial asset over a short window of time. For example, the short-memory model may be based on asset performance over a period of time that is defined by an operator (e.g., a time period of less than two months). As such, the short memory model may model behavior of an industrial asset based on a short window of time, SW, that may be fixed. Since SW may comprise a fixed number of samples, as new data is received, the oldest data may be removed from SW so that a size of SW remains constant.

At 220, a long-memory model (L) associated with the industrial asset may be determined. The long-memory model associated with the industrial asset may also comprise any type of model such as, but not limited to, a physics based model or a data-driven model. The long-memory model may be based on performance of the industrial asset over a long window of time. For example, the long-memory model may be based on asset performance over a period of time that is greater than two months (e.g., a one year period). As such, the long memory model may comprise a long window (LW) of time that an industrial asset has been in operation. In some embodiments, LW may be a fixed size window and as new data is received, the oldest data is removed so that a size of LW remains constant.

At 230, the short-memory model (S) may be determined to more accurately reflect an actual operation of the industrial asset than the long-memory model (L) based on comparing currently received operational data to an outcome of the short-memory model and an outcome of the long-memory model.

As described above, the present embodiments relate to the use of two models: the long-memory model that is trained based on a long-time window (LW) and the short-memory model that is trained based on a short window (SW). Since both L and S may both receive the same data, SW may comprise a subset of LW. When the concept drift is stationary (e.g. there is no determinable drift), L performs no worse than S since the training data of S may be a subset of L. However, when concept drift is present, S may adapt faster since a percentage of newer samples in SW is typically much higher than LW. For example, if SW covers a two-month period of time (e.g. 60 samples), and LW covers a one year period of time (e.g., 365 samples), 10 new samples will comprise 16.7% of SW and only 0.03% of LW. Therefore, the 10 new samples may have a greater impact on an outcome of S than the samples will for L.

For purposes of illustrating features of the present embodiments, some simple examples will now be introduced and referenced throughout the disclosure. Those skilled in the art will recognize that these examples are illustrative and are not limiting and are provided purely for explanatory purposes.

In a first example, a locomotive is monitored by a monitoring platform to determine a likelihood of when failures may occur. For example, locomotive wheels undergo considerable mechanical stress and metal fatigue which may lead to a gradual flattening or cracking of portions of the wheel tread which can create deformities in the wheels. These deformities may damage rails as the locomotive passes over the rails and may depend on shifting environmental factors. Moreover, if the wheels flatten to a point where they become too wide, then the rail vehicle may become derailed while in operation.

In operation, as a new batch of data samples is received from the locomotive, S and L may be individually used to model predicted failures of the locomotive based on the new samples. If a performance of L is acceptable (e.g., performance of L closely matches the received data or is within a predefined margin of error) then L may be updated using information in the new batch of data samples (e.g., the window LW will include the new batch of data samples). However, if the performance of L does not closely match the new batch of data samples or is outside a predefined margin of error, but the performance of S closely matches the new batch of data samples, this may be an indication of concept drift (e.g., the short-term model is better tracking changes than a long-term model). For purposes of this example, it will be assumed that the performance of L does not closely match the new batch of data samples but that the performance of S more closely matches the new batch of data samples.

In a second example, a power plant is being monitored by a monitoring platform to monitor for inefficiency of the power plant. As components of a power plant wear with age and heat, the power plant may run more inefficiently (e.g., it takes more fuel to generate a same amount of power and thus running the power plant inefficiently may cause a financial loss). As the power plant is in operation, a new batch of data samples may be received at a monitoring platform and may be analyzed using both S and L. As described above, if performance of L is acceptable (e.g., performance of L closely matches the received the received data) then L may be updated using information from the new batch of data samples (e.g., the window LW will include the new batch of data samples). However, if the performance of L does not closely match the new batch of data samples, but the performance of S more closely matches new batch of data samples, this may be an indication of concept drift. For purposes of this example, it will be assumed that the performance of L does not closely match the new batch of data samples but that the performance of S more closely matches the new batch of data samples.

Next, at 240, the long-memory model may be updated based on the short-memory model. Updating the long-memory model based on the short-memory model may be in response to the determination that the performance of S more closely matches the new batch of data samples. Furthermore, updating the long-memory model based on the short-memory model may comprise replacing LW by truncating LW to be a same size window as SW (which has been recently updated), so that all information prior to SW (and its recent update) is retired and then the fixed-sized SW window may continue forward with the most updated information.

Continuing with the above-examples, SW associated with the locomotive may be updated with the new samples and the long-memory model window, LW, also associated with the locomotive, may be truncated so that LW comprises a same size window as SW and all information prior to SW is retired and then the fixed-sized SW window may continue forward with most updated information. Likewise, the long-memory model window, LW, associated with the power plant may be truncated so that LW comprises a same size window as SW associated with the power plant and all information prior to SW is retired and then the fixed-sized SW window may continue forward with most updated information.

At 250, an industrial asset event may be determined. In some embodiments, the industrial asset event may be based on both the short-memory model and the long-memory model. The determination of an industrial asset event may comprise determining a likelihood of the industrial asset requiring a maintenance event (e.g. a repair), an operational change (e.g., change a mode in which the industrial asset operates), a fuel change (e.g., determine an optimal time to operate an industrial asset using a specific type of fuel, switch fuel or fuel sources, or to turn off the industrial asset and use a different asset that uses a different type of fuel), and/or a part change event (e.g., update parts on an industrial asset prior to failure). In some embodiments, the determination of an industrial asset event may automatically trigger an action in accordance with the predication. For example, each asset event may trigger a response based on a type of prediction.

Continuing with the above-examples, the indication of concept drift being present may not only be used to update L but, in response to the indication of concept drift, a scheduled maintenance or scheduled service procedure on the locomotive may automatically be changed to reflect the predication based on concept drift. For example, if increased temperatures and humidity, as indicated by S, have shortened a lifespan of a locomotive wheel, the locomotive may be scheduled sooner than usual for maintenance on the wheels. Determining a maintenance event sooner than normal may allow for replacement of one or more components that are nearing an end of their predicted life span and allow for determining a time to take the industrial asset offline that minimizes disruption to services or a time for dispatching a repair crew. Likewise, if colder than normal temperatures in which a power plant is currently operating has increased wear of components (and thus creates a prediction of a lowered efficiency), the power plant may be scheduled sooner than usual for maintenance or a maintenance crew may be automatically dispatched to address the predicted lowered efficiency.

In some embodiments, the industrial asset event may be based on one of the short- memory model and the long-memory model. In some embodiments, a determination (e.g., a predication) of an industrial asset event using L and S may be chosen alternatively. In some embodiments, S may act as a clutch to determine a boundary of each concept (LW), and may serve as a change detector as well as providing a baseline after change.

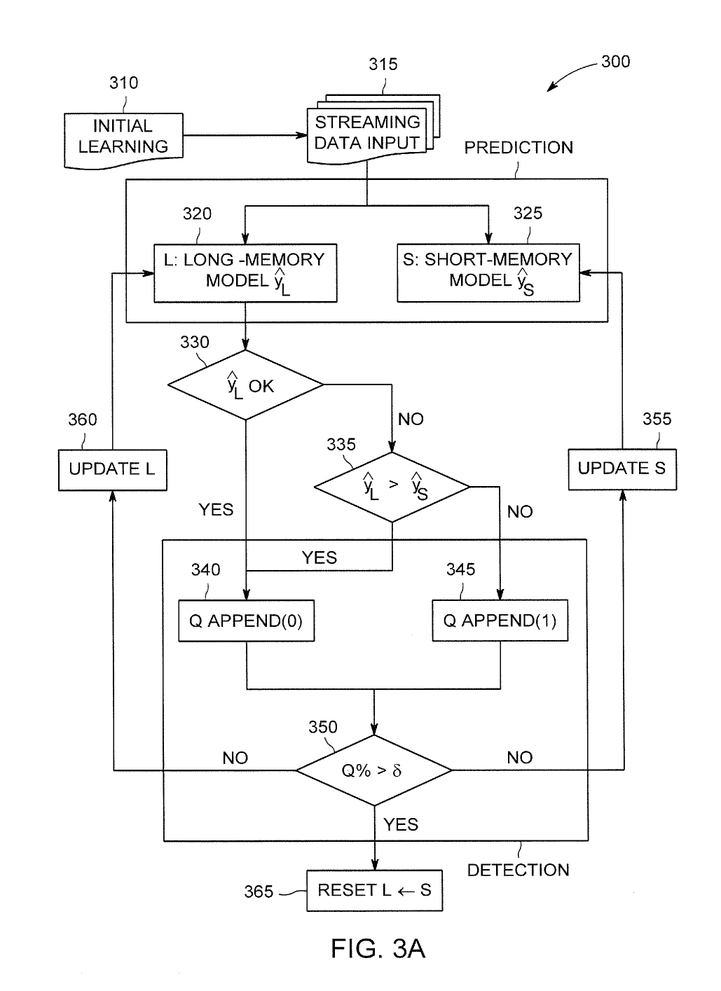

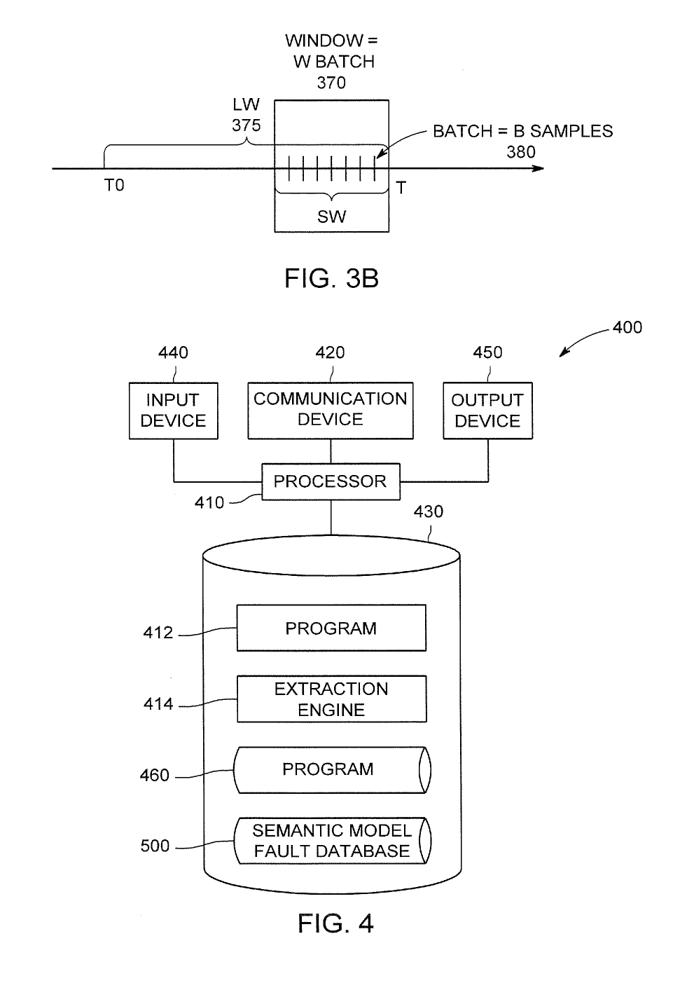

FIG. 3A illustrates a method 300 that may be performed by the monitoring platform 120 of the system 100 described with respect to FIG. 1. The flow chart described herein does not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

In some embodiments, method 300 may relate to a work flow for managing alternating learners. Furthermore, method 300 may relate to a prediction unit for incrementally updating a model to learn from most recently received data and a detection unit for checking stationarity of data streams.

At 310, an initial dataset may be received at a modeling system. A streaming data input from an industrial asset may be received at 315. Based on the streaming data input, a long-memory model (L) may be created at 320 and a short-memory model (S) may be created at 325. At 330, a performance of L may be compared with the received streaming data input 315. In a case that the performance of L is within a predetermined margin of error, the newly received streaming data input 315 may registered in a queue Q with a zero indicator at 340. However, if a comparison of the streaming data input 315 with L is outside the predetermined margin of error at 335 then the new streaming data may be registered in the queue Q with a one. The queue Q may be used to register a status of a performance comparison between L and S. For example, a one may be registered whenever S outperforms L in a meaningful way, otherwise a zero is registered. The comparison made at 335 may relate to a case when S outperforms L in a meaningful way (e.g., performance of S and L differ significantly, and S is closer to the performance of the currently received data). Therefore, if, at 335 the performance of L is greater than S, then the new streaming data may be registered in the queue Q with a zero at 340.

As illustrated in FIG. 3B, queue Q may comprise a maximum length of W 370. When a new concept drift is determined, window LW 375 may be reduced in size to match SW by setting T0:=T−W, and also by resetting L by S, so that the performance of L after the reset is not arbitrarily bad. As further illustrated in FIG. 3B, a batch of samples 380 may be changed in window LW 370. Referring back to FIG. 3A, at 350, it is determined if concept drift is present based on determining that a rate of ones in the queue Q exceeds a user defined threshold. If concept drift is present based on the number of ones in queue Q being greater than the user defined threshold, then L is reset with S. If it is determined that concept drift is not present, then S is updated with the new data at 355 and Y is updated with the new data at 360.

Note the embodiments described herein may be implemented using any number of different hardware configurations. For example, FIG. 4 illustrates a monitoring platform 400 that may be, for example, associated with the system 100 of FIG. 1. The monitoring platform 400 may provide a technical and commercial advantage by creating a prediction tool, that causes minimal changes to existing assets. Furthermore, the monitoring platform 400 may provide advisory alerts based on predicted asset events that can be used to plan outages instead of reacting to a failure of an industrial asset that is currently in operation.

The monitoring platform 400 may comprise a processor 410 (“processor”), such as one or more commercially available Central Processing Units (CPUs) in the form of one-chip microprocessors, coupled to a communication device 420 configured to communicate via a communication network (not shown in FIG. 4). The communication device 420 may be used to communicate, for example, with one or more users. The monitoring platform 400 further includes an input device 440 (e.g., a mouse and/or keyboard to enter information about the boiler and/or the boiler tubing) and an output device 450 (e.g., to output and display the data and/or alerts).

The processor 410 also communicates with a memory/storage device 430 that stores data 414. The storage device 430 may comprise any appropriate information storage device, including combinations of magnetic storage devices (e.g., a hard disk drive), optical storage devices, mobile telephones, and/or semiconductor memory devices. The storage device 430 may store a program 412/460 and/or processing logic for controlling the processor 410. The processor 410 performs instructions of the programs 412, 460, and thereby operates in accordance with any of the embodiments described herein. For example, the processor 410 may receive data such as, but not limited to, sensor data or data from a repository and may create a model based on the data and/or may also detect a likelihood of an industrial asset event via the instructions of the programs 412 and processing logic.

The programs 412, 460 may be stored in a compiled, compressed, uncompiled and/or encrypted format or a combination. The programs 412, 460 may furthermore include other program elements, such as an operating system, a database management system, and/or device drivers used by the processor 410 to interface with peripheral devices. The device may also comprise an extraction engine 414 and a fault database 500.

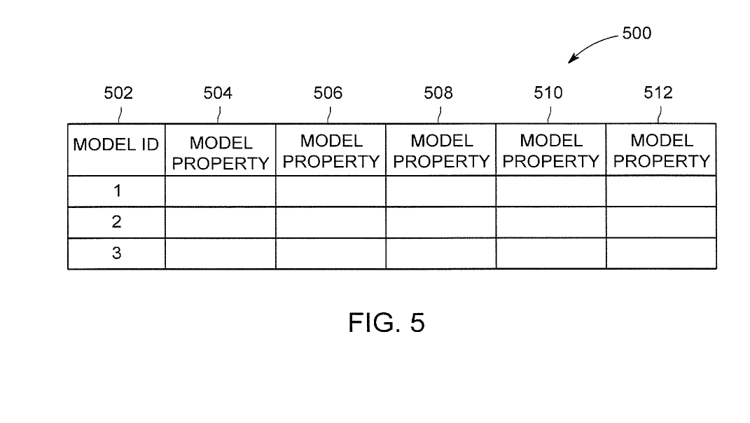

FIG. 5 is a tabular view of a portion of a database 500 in accordance with some embodiments of the present invention. The table includes entries associated with assets such as, but not limited to, fuel related properties, environmental properties, material related data and/or operational parameters. The table also defines fields 502, 504, 506, 508, 510, 512, 514 and 516 for each of the entries. The fields, for example, may specify: an industrial asset ID 502, a first asset related property 504, a second asset related property 506, a third asset related property 505, a fourth asset related property 510, and an nth asset related property 512. The information in the database 500 may be periodically created and updated based on information collection during operation of an industrial asset and as they are received from one or more sensors.

The industrial asset ID 502 might be a unique alphanumeric code identifying a specific asset and the industrial asset properties 504/506/508/510/512/514/516 might provide information related to features associated with a specific asset such as, but not limited to, fuel related properties, environmental properties, material related data and/or operational parameters.

As used herein, information may be “received” by or “transmitted” to, for example: (i) the monitoring platform 600 from another device; or (ii) a software application or module within the monitoring platform 600 from another software application, module, or any other source.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The process flow and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a geometrical compensation module. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed:

1. A system to determine an industrial asset event, the system comprising:
a processor; and
a non-transitory computer-readable medium comprising instructions that when executed by the processor perform a method, the instructions to:
determine a short-memory model associated with an industrial asset;
determine a long-memory model associated with the industrial asset; and
determine, via the processor, an industrial asset event based on the short-memory model and the long-memory model.

2. The system of claim 1, wherein the short-memory model is based on performance of the industrial asset over a period of time that is less than two months.

3. The system of claim 1, wherein the long-memory model is based on performance of the industrial asset over a period of time that is greater than two months.

4. The system of claim 1, wherein prior to determining the industrial asset event, (i) determining that the short-memory model more accurately reflects actual operation of the industrial asset than the long-memory model based on comparing current operational data to an outcome of the short-memory model and an outcome of the long-memory model and (ii) updating the long-memory model based on the short-memory model.

5. The system of claim 1, wherein the industrial asset event comprises a maintenance event and wherein determining the maintenance event comprises (i) determining that one or more components of the industrial asset is nearing an end of their predicted life span and (ii) determining a time to take the industrial asset offline that minimizes disruption to services.

6. The system of claim 5, wherein determining the maintenance event further comprises determining a time to dispatch a repair crew.

7. The system of claim 1, wherein the industrial asset event comprises determining a forecasted financial loss due to inefficiency of the industrial asset and scheduling a technician to maintain and repair the industrial asset.

8. The system of claim 1, wherein determining the industrial asset event comprises determining an optimal time to switch from a first fuel source to a second fuel source based on operating conditions.

9. A non-transitory computer-readable medium comprising instructions that when executed by a processor perform a method to determine an industrial asset event, the instructions to:
determine a short-memory model associated with an industrial asset;
determine a long-memory model associated with the industrial asset;
determine that the short-memory model more accurately reflects actual operation of the industrial asset than the long-memory model based on comparing current operational data to an outcome of the short-memory model and an outcome of the long-memory model;
in response to determining that the short-memory model more accurately reflects actual operation of the industrial asset, update the long-memory model based on the short-memory model; and
determine, via a processor, an industrial asset event based on the long-memory model.

10. The non-transitory computer-readable medium of claim 9, wherein the short-memory model is based on performance of the industrial asset over a period of time that is less than two months.

11. The non-transitory computer-readable medium of claim 9, wherein the long-memory model is based on performance of the industrial asset over a period of time that is greater than two months.

12. The non-transitory computer-readable medium of claim 9, wherein the industrial asset event comprises a maintenance event and wherein determining the maintenance event comprises (i) determining that one or more components of the industrial asset is nearing an end of their predicted life span and (ii) determining a time to take the industrial asset offline that minimizes disruption to services.

13. The non-transitory computer-readable medium of claim 12, wherein determining the maintenance event further comprises determining a time to dispatch a repair crew.

14. The non-transitory computer-readable medium of claim 9, wherein the industrial asset event comprises determining a forecasted financial loss due to inefficiency of the industrial asset and scheduling a technician to maintain and repair the industrial asset.

15. The non-transitory computer-readable medium of claim 9, wherein determining the industrial asset event comprises determining an optimal time to switch from a first fuel source to a second fuel source based on operational conditions.

16. A method to determine an industrial asset event, the method comprising:
determining a short-memory model associated with an industrial asset;
determining a long-memory model associated with the industrial asset;
determining that the short-memory model more accurately reflects actual operation of the industrial asset than the long-memory model based on comparing current operational data to an outcome of the short-memory model and an outcome of the long-memory model;
in response to determining that the short-memory model more accurately reflects actual operation of the industrial asset, updating the long-memory model based on the short-memory model; and
determining, via a processor, an industrial asset event based on the long-memory model.

17. The method of claim 16, wherein the short-memory model is based on performance of the industrial asset over a period of time that is less than two months and the long-memory model is based on performance of the industrial asset over a period of time that is greater than two months.

18. The method of claim 16, wherein the industrial asset event comprises a maintenance event and wherein determining the maintenance event comprises (i) determining that one or more components of the industrial asset is nearing an end of their predicted life span, (ii) determining a time to take the industrial asset offline that minimizes disruption to services, and (iii) determining a time to dispatch a repair crew.

19. The method of claim 16, wherein the industrial asset event comprises determining a forecasted financial loss due to inefficiency of the industrial asset and scheduling a technician to maintain and repair the industrial asset.

20. The method of claim 16, wherein determining the industrial asset event comprises determining an optimal time to switch from a first fuel source to a second fuel source based on operational conditions.
